(19) United States
(12) Patent Application Publication
(10) Pub. No.: US 2019/0349571 A1
(43) Pub. Date: Nov. 14, 2019

(54) DISTORTION CORRECTION FOR VEHICLE SURROUND VIEW CAMERA PROJECTIONS

(71) Applicant: Ford Global Technologies, LLC, Dearborn, MI (US)

(72) Inventors: David Michael Herman, Southfield, MI (US); Nunzio DeCia, Northville, MI (US); David Joseph Orris, Southgate, MI (US); Stephen Jay Orris, JR., New Boston, MI (US)

(21) Appl. No.: 15/977,329

(22) Filed: May 11, 2018

(51) Int. Cl. H04N 13/271; H04N 13/282; B60R 1/00

(52) U.S. Cl. CPC H04N 13/271; H04N 13/282; B60R 1/00; B60R 2300/60; B60R 2300/20; B60R 2300/303; B60R 2300/306; B60R 2300/105

(57) ABSTRACT

Method and apparatus are disclosed for distortion correction for vehicle surround view camera projections. An example vehicle includes cameras to capture images of a perimeter around the vehicle and a processor. The processor, using the images, generates a composite image of an area around the vehicle, and generates a depth map that defines spatial relationships between the vehicle and objects around the vehicle. The processor also generates a projection surface using the depth map. Additionally, the processor presents an interface for generating a view image based on the composite image projected onto the projection surface.

### TECHNICAL FIELD

The present disclosure generally relates to a camera system of a vehicle and, more specifically, distortion correction for vehicle surround view camera projections.

### BACKGROUND

Vehicles include camera systems that stitch together images captured around the vehicle to form a pseudo-three dimensional image of the area round the vehicle. To create this view, these camera systems project the stitched together images onto a projection surface that assumes that the surface around the vehicle is an infinite plane. However, when an object intersects with a boundary of this projection surface, the object becomes noticeably distorted in the pseudo-three dimensional image. In such scenarios, operators have a difficult time gaining useful information from the pseudo-three dimensional images

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for distortion correction for vehicle surround view camera projections. An example vehicle includes cameras to capture images of a perimeter around the vehicle and a processor. The processor, using the images, generates a composite image of an area around the vehicle, and generates a depth map that defines spatial relationships between the vehicle and objects around the vehicle. The processor also generates a projection surface using the depth map. Additionally, the processor presents an interface for generating a view image based on the composite image projected onto the projection surface.

An example method to generate an image of an area around a vehicle from a perspective not directly observable by cameras of the vehicle includes capturing, with the cameras, images of a perimeter around the vehicle. The method also includes, using the images, (a) generating a composite image of an area around the vehicle, and (b) generating a depth map that defines spatial relationships between the vehicle and objects around the vehicle. The method includes generating a projection surface using the depth map. Additionally, the method includes presenting an interface for generating a view image based on the composite image projected onto the projection surface.

An example vehicle includes a first set of cameras to capture first images of a perimeter around the vehicle and a second set of cameras to capture second images of a perimeter around the vehicle. The example vehicle also includes a processor. The processor generates a composite image of an area around the vehicle using the first images and generates a depth map that defines spatial relationships between the vehicle and objects around the vehicle using the second images. The processor then generates a projection surface using the depth map. The processor also presents an interface for generating a view image based on the composite image projected onto the projection surface.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle operating in accordance with the teachings of this disclosure.

FIG. 2A illustrates a virtual camera for generating an isometric image of a three-dimensional area around the vehicle of FIG. 1 using a standard projection surface.

FIG. 2B illustrates a representation of the standard projection surface of FIG. 2A.

FIG. 3A illustrates the virtual camera for generating the isometric image of a three-dimensional area around the vehicle of FIG. 1 using an altered projection surface with portions of the area around the vehicle darkened to represent areas not captured by the camera.

FIG. 3B illustrates the virtual camera for generating the isometric image of a three-dimensional area around the vehicle of FIG. 1 using an altered projection surface with portions of the area around the vehicle modeled to represent areas not captured by the camera.

FIG. 3C illustrates a representation of an example altered projection surface of FIGS. 3A and 3B.

FIG. 4 illustrates an example of a distorted three dimensional image.

FIG. 5 illustrates an example of a corrected three dimensional image.

FIG. 6 is a block diagram of the electronic components of the vehicle of FIG. 1.

FIG. 7 is a flowchart of a method to generate the corrected three dimensional image, which may be implemented by the electronic components of FIG. 6.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Increasingly, vehicles include camera systems that generate a virtual isometric or top-down view of the three dimensional area around the vehicle. These images are sent to a computing device (e.g., vehicle display and infotainment engine control module (ECU), a desktop computer, a mobile device, etc.) to facilitate a user monitoring the area around the vehicle. Often, the user may interact with the image to move a viewport of a virtual camera to view the vehicle and it's surroundings at different angles. However, these camera system generate these isometric images based the characteristics of the three-dimensional area around the vehicle using images captures by cameras (e.g., a 360 degree camera system, ultra-wide angle cameras positioned on the peripheral of the vehicle, etc.), stitching them together, and projecting the stitched image onto a projection surface. This “standard” projection surface is based on ray tracing modeling outward from the cameras towards an infinitely flat ground plane and then projecting a three-dimensional surface to intersect the camera pixel rays a “reasonable” distance from the virtual vehicle in the three-dimensional view. As a consequence, this projection surface is shaped like a smooth bowl that flattens out near the virtual location of the vehicle. The projection surface defines the shape of a virtual object surrounding the vehicle and onto which the pixels of the images are mapped. As such, the projection surface represents a virtual boundary around the vehicle. Projecting the image onto the bowl-like projects surface produces distortions, but these distortions are manageable when objects are relatively far from the vehicle. However, when an object approaches or intersects the projection surface (e.g., crosses the virtual boundary) the object becomes increasingly distorted eventually resulting in the generated isometric images to be incomprehensible. Because this vehicle feature is commonly used in parking situations where adjacent vehicles or objects are expected to be near or interior to the projection surface, the isometric views of the three dimensional scene frequently have noticeable distortions of the area around the vehicle that are displayed to the user.

As described herein, the vehicle generates an image of an area around the vehicle from a perspective distinct from individual camera perspective of the vehicle (e.g. an isometric perspective above the vehicle at varying rotations and inclinations, top-down, etc.) which commonly includes visual information from multiple cameras attached to the vehicle. The vehicle uses sensors that produce point cloud information (e.g., ultrasonic sensors, radar, lidar, etc.) and/or cameras which produce two dimensional images (e.g., a 360 degree camera systems, ultra-wide angle cameras, panoptic cameras, standard cameras, individual camera images from a photometric stereo camera system, etc.) and/or cameras which produce depth maps (e.g. time of flight camera, photometric stereo camera system) to detect and define the three-dimensional structures around the vehicle (sometimes the depth maps are referred to as “disparity maps”). In some examples, the vehicle creates a voxel depth map or a pixel depth map using the sensor and/or image data and a trained neural network. In some such examples, the depth information based on the images is combined with the depth information from the sensors (sometimes referred to as “sensor fusion”). In some examples, the vehicle recognizes the three-dimensional structures around the vehicle using the sensor and/or image data and determine dimensions and orientations of each detected structure based on a database of known structures. In some examples, while the vehicle is in motion (e.g., when initially parking), the vehicle uses a structure-of-motion technique to determines the three-dimensional structure and/or depth of objects near the vehicle. When the detected objects intersect the projection surface, the vehicle alters the projection surface to account for the portion of the object that crosses the projection surface. To account for the “closer” objects, the system of the current disclosure changes the radial distance of the projection surface around the vehicle corresponding to the location of the object to reduce the distortion. The alteration causes the projection surface to have an decreased radius towards the origin of the projection surface (e.g. the vehicle's center centroid) that has the approximate shape of the portion of the object that crosses the projection surface. In such a manner, when the stitched image is projected onto the altered projection surface, the isometric view image is not distorted because the ray tracing of the virtual camera is substantially identical to the ray tracing of the camera attached to the vehicle that captured the image. The vehicle uses a virtual camera to facilitate a user viewing the area around the vehicle (e.g., different portions of the stitched image projected onto the projection surface). The image generated by the perspective of the virtual camera is transmitted to an interior vehicle display or a remote device, such as a mobile device (e.g., a smart phone, a smart watch, etc.) and/or a computing device (e.g., a desktop computer, a laptop computer, a tablet computer, etc.).

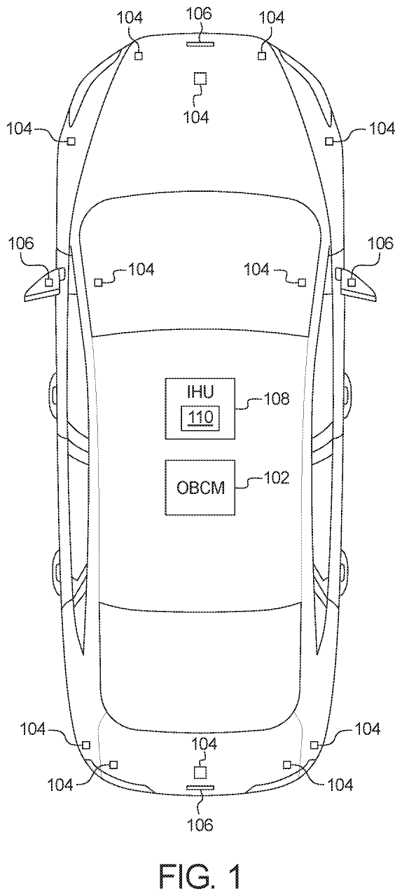

FIG. 1 illustrates a vehicle 100 operating in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 may be any type of motor vehicle, such as a car, a truck, a semi-trailer truck, or a motorcycle, etc. Additionally, in some examples, the vehicle 100 is towing a trailer (which, as discussed below, may be treated as part of the vehicle 100). The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). The vehicle may be stationary or in motion during image capture. In the illustrated example the vehicle 100 includes an on-board communication module (OBCM) 102, sensors 104, cameras 106, and an infotainment head unit (IHU) 108.

The on-board communications module 102 includes wired or wireless network interfaces to enable communication with external networks. The on-board communications module 102 includes hardware (e.g., processors, memory, storage, antenna, etc.) and software to control the wired or wireless network interfaces. In the illustrated example, the on-board communications module 102 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); local area wireless network (including IEEE 802.11 a/b/g/n/ac or others), and Wireless Gigabit (IEEE 802.11ad), etc.). In some examples, the on-board communications module 102 includes a wired or wireless interface (e.g., an auxiliary port, a Universal Serial Bus (USB) port, a Bluetooth® wireless node, etc.) to communicatively couple with a mobile device (e.g., a smart phone, a smart watch, a tablet, etc.). In some examples, the on-board communications module 102 communicatively coupled to the mobile device via the wired or wireless connection. Additionally, in some examples, the vehicle 100 may communicated with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

The on-board communications module 102 is used to send and receive data from a mobile device and/or a computing device. The mobile device and/or a computing device then interacts with the vehicle via an application or an interface accessed via a web browser. In some examples, the on-board communications module 102 communicatively couples with an external server via the external network (e.g. General Motors® OnStar® and/or Ford® MyPass®, etc.) to relay the information between the on-board communications module 102 and the computing device. For example, the on-board communications module 102 may send images generated based on a view of a virtual camera to the external server and may receive commands to change the view of the virtual camera from the external server.

The sensors 104 are positioned around the exterior of the vehicle 100 to observe and measure the environment around the vehicle 100. In the illustrated example, the sensors 104 include range detection sensors that measure distances of objects relative to the vehicle 100. The range detection sensors include ultrasonic sensors, infrared sensors, short-range radar, long-range radar, and/or lidar.

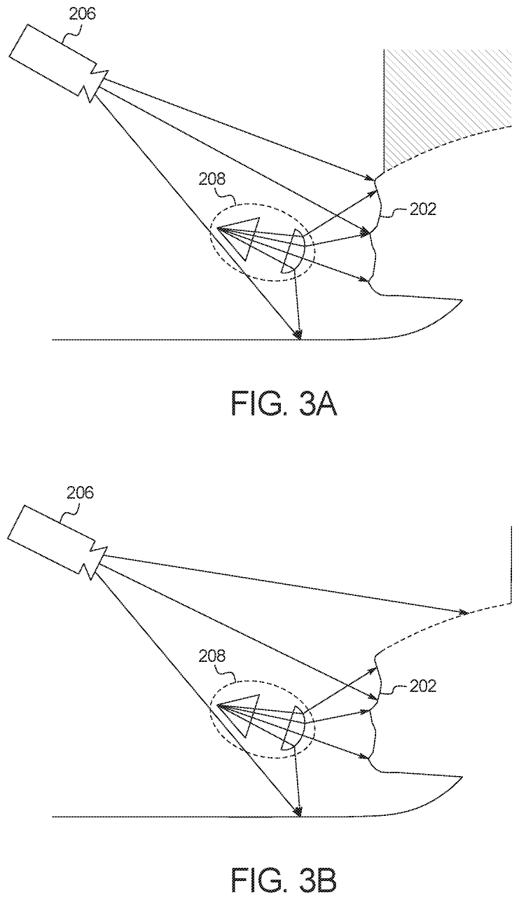

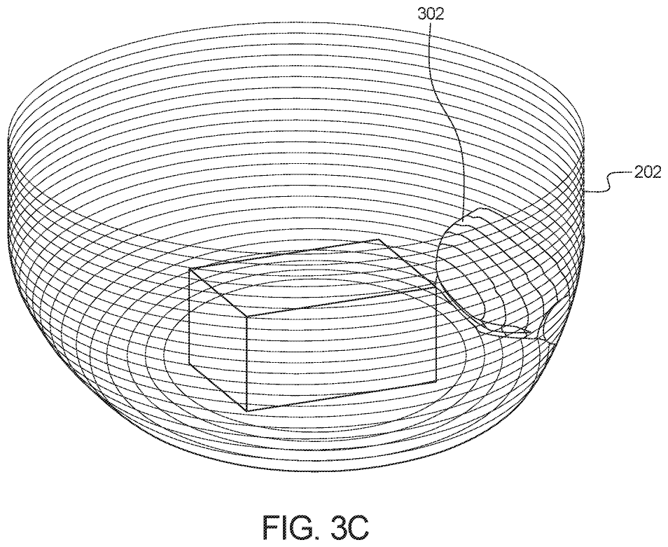

The cameras 106 capture images of the around the vehicle 100. As describe below, these images are used to generate a depth map to alter the projection surface (e.g., the projection surface 202 of FIGS. 3A and 3B below) and to be stitched together to be projected onto the projection surface. In some examples, the cameras 106 are mounted on side view mirrors or the B-pillar, and the front of the vehicle 100 near the license plate holder, and the rear of the vehicle 100 near the license plate holder. The cameras 106 may be one or more of a 360 degree camera systems, ultra-wide angle cameras, panoptic cameras, standard cameras, and/or a photometric stereo camera system. The cameras 106 may be color or monochrome. In some examples, the cameras 106 include different types of cameras to provide different information about the area around the vehicle. For example, the cameras 106 may include ultra-wide angle cameras to be used to capture images to be projected on the projection surface and photometric stereo cameras to capture images to generate a depth map. The cameras 106 are positioned on the vehicle 100 such that the captured images provide a complete view of the surrounding perimeter.

The infotainment head unit 108 provides an interface between the vehicle 100 and a user. The infotainment head unit 108 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 108 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, in some examples, the infotainment head unit 108 displays the infotainment system on, for example, the center console display. In some examples, the infotainment system provides an interface to facilitate the user viewing and/or manipulating images generated by the vehicle 100 and/or set preferences. In the illustrated example, the infotainment head unit 108 include an image generator 110.

The image generator 110 generates a virtual perspective image (e.g. isometric view, top-down view, etc.) from a pseudo three-dimensional image of the area around the vehicle 100 and generates an image to be displayed to the user based on a virtual camera view of the pseudo three-dimensional image. The image generator 110 captures images of the area around the vehicle 100 with the cameras 106. The image generator 110 stitches the captured images together to generate a 360 degree view around the vehicle 100. Stitching the captured images together manipulates the images such that the stitched image provides a complete view of the perimeter surrounding the vehicle 100 (e.g., the cameras 106 may not capture images of the area above the vehicle 100 or areas above a certain angle above the ground).

In some examples, to take images to use to create a depth map, the image generator 110 flashes one or more visible or near infrared light(s) (e.g., via a body control module) to enhance the depth detection in the images using a using photometric stereo three dimensional imaging technique. In such examples, images used to generate the depth map are different that image stitched together to be projected onto the projection surface.

The image generator 110 analyzes the captured images to produce the depth map to determine dimensions of objects proximate to the vehicle 100. In some examples, the image generator 110 uses a trained neural network to either produce a voxel depth map or a per pixel depth map. Examples of producing voxel depth maps or per pixel depth maps using neural networks are described in (a) Zhu, Zhuotun, et al. “Deep learning representation using autoencoder for 3D shape retrieval.” Neurocomputing 204 (2016): 41-50, (b) Eigen, David, Christian Puhrsch, and Rob Fergus. “Depth map prediction from a single image using a multi-scale deep network.” Advances in neural information processing systems. 2014, (c) Zhang, Y. et al. A fast 3D reconstruction system with a low-cost camera accessory. Sci. Rep. 5, 10909; doi: 10.1038/srep10909 (2015), and (d) Hui, Tak-Wai, Chen Change Loy, and Xiaoou Tang. “Depth map super-resolution by deep multi-scale guidance.” European Conference on Computer Vision. Springer International Publishing, 2016, all of which are incorporated by reference herein in their entirety. In some examples, the image generator 110 generates a three-dimensional point cloud using measurements from the sensors 104. The image generator 110 then transforms the three-dimensional point cloud into a voxel depth map or per pixel depth map. In some such examples, the depth map generated from the image and the depth map generated from the sensor data are merged. In some example, the image generator performs object recognition on the images to identify objects in the images. In such examples, the image generator 110 retrieves a three-dimensional geometry of recognized object from a database (e.g., a database residing on the external server, a database stored in computer memory, etc.) and inserts the three-dimensional geometry into the depth map based on the pose (e.g., distance, relative angle, etc.) of the detected object.

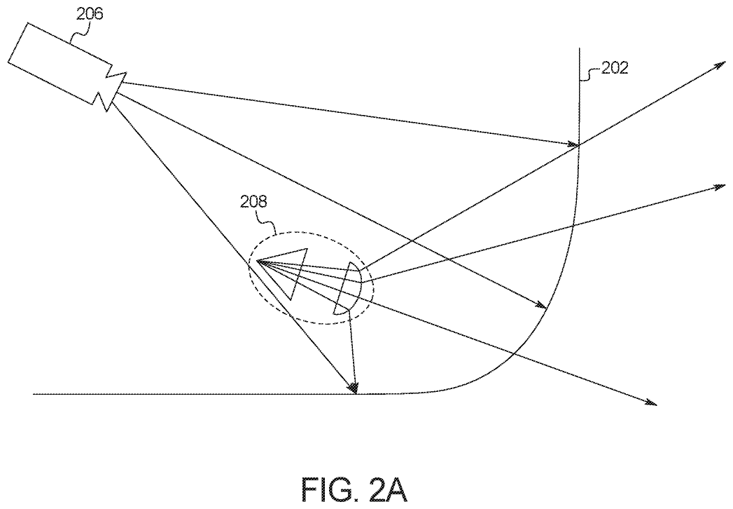

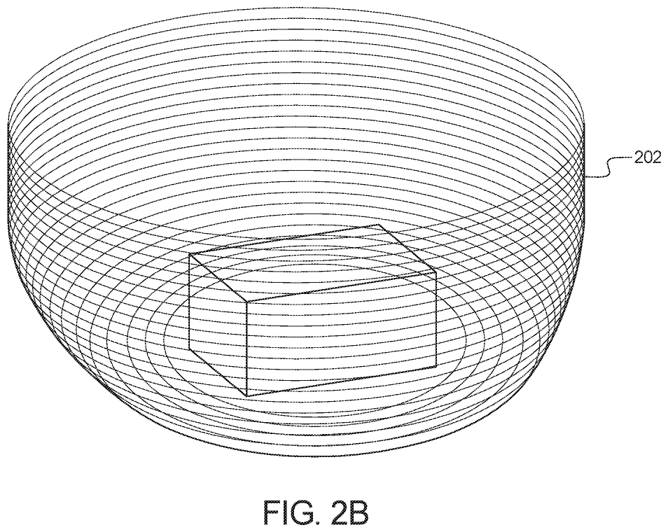

The image generator 110 defines a projection surface. FIG. 2A illustrates cross-section of a default projection surface 202 (sometimes referred to as a “standard projection surface”). FIG. 2B illustrates an example three-dimensional representation of the default projection surface 202. The projection surface 202 is a virtual object that is defined to so that the boundary of the projection surface 202 is a distance from the vehicle 100 in a bowl shape. That is, the projection surface 202 is representative of a curved surface that surrounds the vehicle 100. Using the virtual representation of object around the vehicle 100 as represented in the depth map, the image generator 110 determines whether objects near the vehicle 100 cross the boundary of the projection surface 202. When objects intersect the boundary of the projection surface 202, the image generator 110 alters the projection surface 202 to conform to the shape of the portion of the object that intersects the boundary of the projection surface 202. FIGS. 3A and 3B illustrate cross-sections of an altered projection surface 202. FIG. 3C illustrated an example three-dimensional presentation of the altered projection surface 202. In the illustrated example, the front of a vehicle 100 is intercepting the boundary of the projection surface 202 and the image generator alters the projection surface 202 to conform to the shape of the vehicle. In FIG. 3C the front of the vehicle 100 causes an indentation 302 into the projection surface (the size of the projection surface 202 and the indentation 302 being exaggerated for illustrative purposes in FIG. 3C).

After selecting/altering the projection surface 202, the image generator 110 virtually projects (e.g., maps) the stitched image onto the projection surface 202. In some examples, where the vehicle 100 occludes itself or another object, the path off the projection surface 202 and a virtual camera 206 are mapped at that location so to inpaint the isometric view or the pixel values on the projection surface 202. Examples of inpainting to compensate for unknown pixel values is described in Lin, Shu-Chin, Timothy K. Shih, and Hui-Huang Hsu. “Filling holes in 3D scanned model base on 2D image inpainting.” Ubi-media Computing and Workshops (Ubi-Media), 2017 10th International Conference on. IEEE, 2017, which is incorporated by reference herein in its entirety. The image generator 110 defines the virtual camera 206 having a viewport. Using the view from the viewport, the image generator 110 generate a view image of the area around the vehicle 100. In some examples, the virtual scene (e.g., the stitched image projected onto the projection surface 202 and the virtual camera 206) includes a model of the vehicle 100 such that the model of the vehicle 100 may also be in the view image depending on the viewport of the virtual camera 206. The image generator 110 sends the image to a mobile device and/or a computing device (e.g., via the external server). In some examples, the image generator 110 receives instructions to manipulate the viewport of the virtual camera 206 to facilitate a user viewing the area around the vehicle 100 at different angles.

In FIGS. 2A, 3A, and 3B, cross-sections of the viewport of the virtual camera 206 are illustrated as arrows emanating from the virtual camera and intersecting the projection surface 202. A representation of a cross-section of the image projected onto the projection surface 202 is illustrated by arrows emanating from a representation 208 of the camera(s) 106.

In some examples, the image generator 110 limits the location and orientation of the viewport of the virtual camera 206 to prevent areas not represented by the stitched images from being part of the view image. In the example illustrated in FIG. 3A, the image generator 110 applies a black masking 302 to the areas not represented by the stitched images. In such examples, the image generator 110 does not restrict the location and orientation of the viewport of the virtual camera 206. In such examples, the view image may include black sections that correspond to the areas not represented by the stitched images. In the example illustrated in FIG. 3A, the image generator 110 applies a computer generated model of object, a previously captured image, or a substitute image (e.g., of the sky, etc.) to the areas not represented by the stitched images. In such examples, the image generator 110 does not restrict the location and orientation of the viewport of the virtual camera 206. In such examples, the view image may include sections that correspond to the areas not represented by the stitched images that represents physical space not images by the cameras 106.

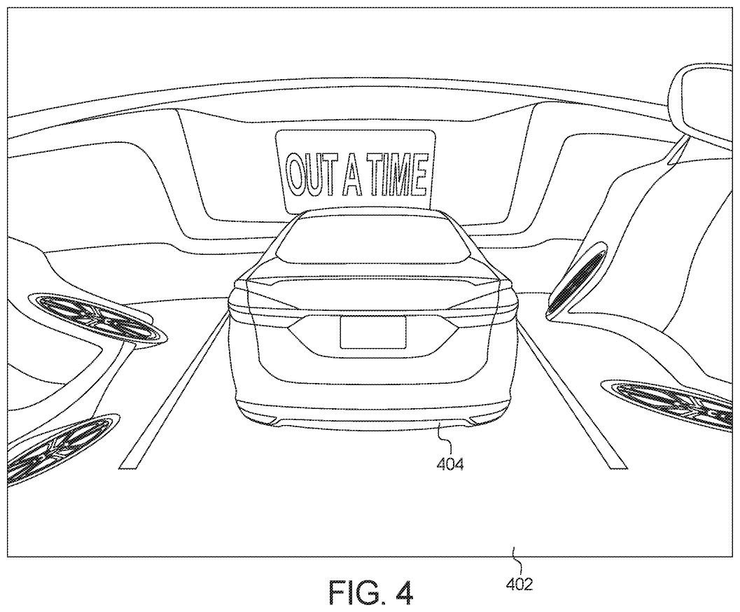

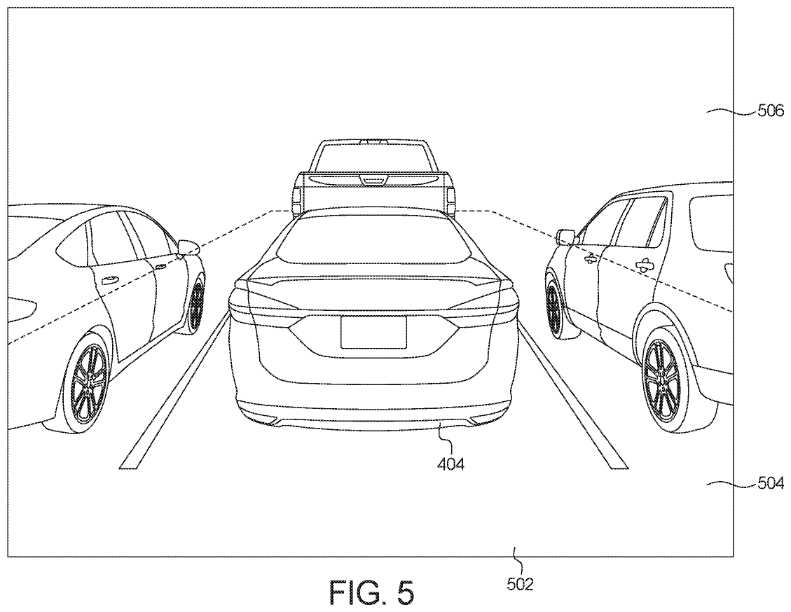

FIG. 4 illustrates an example of the view image 402 provided to the user when objects (e.g., a truck ahead of the vehicle and two sedans to the sides) are closed enough to the vehicle 100 to intersect the boundary of an unaltered projection surface. As illustrated in FIG. 4, the objects that intersect the projection surface are distorted. FIG. 5 illustrates an example of the view image 502 provided to the when the objects are close enough to intersect the boundary of the projection surface and the projection surface is altered (e.g., as illustrated in FIGS. 3A and 3B above). In the illustrated example, the objects are not distorted. In such a manner, the image generator 110 improves the interface provided to the user and solves a technical problem related to generating images based on virtual representations of the vehicle 100. FIG. 5 also illustrates a camera view portion 504 and a non-camera view portion 506. The camera view portion 504 captures the stitched images from the cameras 106 providing an actual view of the area around the vehicle 100. The non-camera view portion 506 presents the area around the vehicle 100 that is not captured by the cameras 106. In some examples, the image generator 110 represents this area on the projection surface 202 with black pixels (e.g., as illustrated in FIG. 3A). Accordingly, in such examples, the non-camera view portion 506 of the generate view image 502 is black. In some examples, using three-dimensional models stored in memory, the image generator 110 estimates the boundaries of the portions of the objects represented in the non-camera view portion 506. In such examples, using the models, the image generator 110 maps the corresponding pixels using the geometry and pose of the models (e.g., as illustrated in FIG. 3B). In some such examples, the image generator 110 also includes a skybox that provides an environment from which to generate the non-camera view portion 506 portion of the view image 503. FIGS. 4 and 5 illustrated a representation 404 of the vehicle 100 (e.g., a wireframe or solid model) that is inserted into the images to represent the location of the vehicle 100 (e.g., since the cameras 106 cannot actually capture images of the vehicle 100).

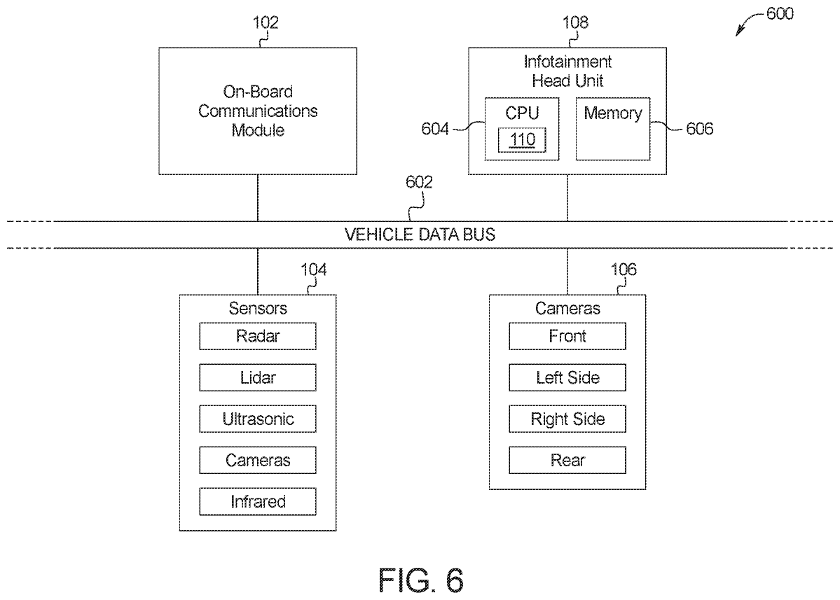

FIG. 6 is a block diagram of electronic components 600 of the vehicle 100 of FIG. 1. In the illustrated example, the electronic components 600 includes the on-board communications module 102, the sensors 104, the cameras 106, the infotainment head unit 108, and a vehicle data bus 602.

The infotainment head unit 108 includes a processor or controller 604 and memory 606. In the illustrated example, the infotainment head unit 108 is structured to include image generator 110. Alternatively, in some examples, the image generator 110 may be incorporated into another electronic control unit (ECU) with its own processor and memory. The processor or controller 604 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 606 may be volatile memory (e.g., RAM, which can include magnetic RAM, ferroelectric RAM, and any other suitable forms of RAM); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc.). In some examples, the memory 606 includes multiple kinds of memory, particularly volatile memory and non-volatile memory.

The memory 606 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 606, the computer readable medium, and/or within the processor 604 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The vehicle data bus 602 communicatively couples the on-board communications module 102, the sensors 104, the cameras 106, and the infotainment head unit 108, and/or other electronic control units (such as the body control module, etc.). In some examples, the vehicle data bus 602 includes one or more data buses. The vehicle data bus 602 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

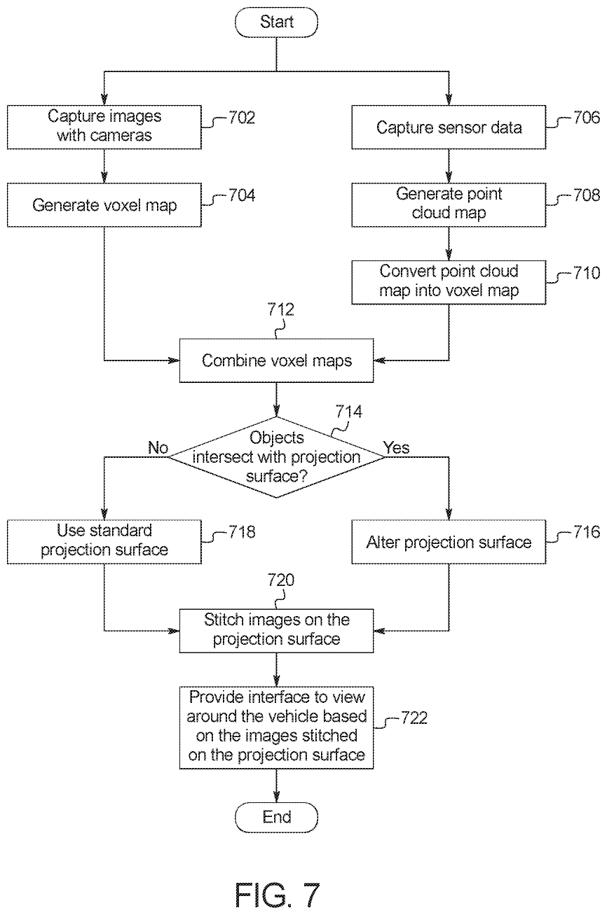

FIG. 7 is a flowchart of a method to generate the corrected view image (e.g., the view image 502 od FIG. 5 above, which may be implemented by the electronic components 600 of FIG. 6. The method of FIG. 7 may be initiated, for example, when a request is received from an infotaintment head unit or mobile device or a computing device via the on-board communications module 102. Initially at block 702, the image generator 110 captures images with the cameras 106 of the area around the vehicle 100. At block 704, the image generator 110 generates a voxel map that characterizes the three dimensional space around the vehicle 100 based on the images captured at block 702. At block 706, the image generator 110 captures data from the sensors 104. At block 708, the image generator 110 transforms the sensor data capture at block 706 into a point cloud map. At block 710, the image generator 110 converts the point cloud map into a voxel map. At block 712, the image generator 110 combines the voxel map generated at block 704 with the voxel map generated at block 710 (e.g. using sensor fusion). Examples of fusing different depth maps are described in Zach, Christopher, “Fast and high quality fusion of depth maps,” Proceedings of the International Symposium on 3D data Processing, Visualization and Transmission (3DPVT), Vol. 1. No. 2. 2008, which is incorporated by reference herein in its entirety.

At block 714, the image generator 110 determines whether the voxel map generated at block 712 indicates that an object near the vehicle 100 intersects the boundary of the projection surface. When an object intersects the boundary of the projection surface, the method continues at block 716. Otherwise, when an object does not intersect the projection surface, the method continues at block 718. At block 716, the image generator 110 alters the projections surface (e.g., generates the projection surface 202 illustrated in FIGS. 3A and 3B) based on the voxel map. At block 718, the image generator uses the standard projection surface (e.g., the projection surface 202 illustrated in FIG. 2). At block 720, the image generator 110 stitched the images captures at block 702 together to form a complete perimeter image around the vehicle 100 and projects the stitched image onto the projection surface. At block 722, the image generator 110 provides an interface (e.g., via a mobile device, via a center console display, via a computing device at a remote location, etc.) to facilitate a user changing the pose (e.g., direction and orientation) of the virtual camera 206 in the viewport to create the view image 502.

The flowchart of FIG. 7 is representative of machine readable instructions stored in memory (such as the memory 606 of FIG. 6) that comprise one or more programs that, when executed by a processor (such as the processor 604 of FIG. 6), cause the infotainment head unit 108 to implement the example image generator 110 of FIGS. 1 and 6. Further, although the example program(s) is/are described with reference to the flowchart illustrated in FIG. 7, many other methods of implementing the example image generator 110 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. As used here, the terms “module” and “unit” refer to hardware with circuitry to provide communication, control and/or monitoring capabilities, often in conjunction with sensors. “Modules” and “units” may also include firmware that executes on the circuitry. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
cameras to capture images of a perimeter around the vehicle;
a processor to:
using the images:
generate a composite image of an area around the vehicle, and
generate a depth map that defines spatial relationships between the vehicle and objects around the vehicle;
generate a projection surface using the depth map; and
present an interface for generating a view image based on the composite image projected onto the projection surface.

2. The vehicle of claim 1, wherein the cameras are photometric stereo cameras.

3. The vehicle of claim 1, wherein to generate the projection surface, the processor is to alter a standard projection surface based on the spatial relationships defined in the depth map to account for portions of the objects that intersect a virtual boundary of the standard projection surface.

4. The vehicle of claim 1, wherein to generate the projection surface, the processor is to determine whether the spatial relationships defined in the depth map indicate that the objects intersect a virtual boundary of a standard projection surface.

5. The vehicle of claim 4, wherein the processor is to:
when the spatial relationships defined in the depth map indicate that the objects intersect the virtual boundary, alter the standard projection surface based on the spatial relationships to account for portions of the objects that intersect the virtual boundary; and
when the spatial relationships defined in the depth map do not indicate that the objects intersect the virtual boundary, select the standard projection surface.

6. A method to generate an image of an area around a vehicle from a perspective not directly observable by cameras of the vehicle, the method comprising:
capturing, with the cameras, images of a perimeter around the vehicle;
using the images, (a) generating, by a vehicle processor, a composite image of the area around the vehicle, and (b) generating, by the vehicle processor, a depth map that defines spatial relationships between the vehicle and objects around the vehicle;
generating, with the vehicle processor, a projection surface using the depth map; and
presenting an interface for generating a view image based on the composite image projected onto the projection surface.

7. The method of claim 6, wherein the cameras are photometric stereo cameras.

8. The method of claim 6, wherein generating the projection surface includes altering a standard projection surface based on the spatial relationships defined in the depth map to account for portions of the objects that intersect a virtual boundary of the standard projection surface.

9. The method of claim 6, wherein generating the projection surface includes determining whether the spatial relationships defined in the depth map indicate that the objects intersect a virtual boundary of a standard projection surface.

10. The method of claim 9, including:
when the spatial relationships defined in the depth map indicate that the objects intersect the virtual boundary, altering the standard projection surface based on the spatial relationships to account for portions of the objects that intersect the virtual boundary; and
when the spatial relationships defined in the depth map do not indicate that the objects intersect the virtual boundary, selecting the standard projection surface.

11. A vehicle comprising:
a first set of cameras to capture first images of a perimeter around the vehicle;
a second set of cameras to capture second images of the perimeter around the vehicle;
a processor to:
generate a composite image of an area around the vehicle using the first images, and
generate a depth map that defines spatial relationships between the vehicle and objects around the vehicle using the second images;
generate a projection surface using the depth map; and
present an interface for generating a view image based on the composite image projected onto the projection surface.

12. The vehicle of claim 11, include range detection sensors, wherein the processor is to:
generate a second depth map using measurements from the range detection sensors; and
generate the projection surface using a combination of the depth map generated using the second images and the second depth map.

13. The vehicle of claim 11, wherein the first set of cameras include a different type of camera than the second set of cameras.

14. The vehicle of claim 11, wherein to generate the projection surface, the processor is to alter a standard projection surface based on the spatial relationships defined in the depth map to account for portions of the objects that intersect a virtual boundary of the standard projection surface.

15. The vehicle of claim 11, wherein to generate the projection surface, the processor is to determine whether the spatial relationships defined in the depth map indicate that the objects intersect a virtual boundary of a standard projection surface.

16. The vehicle of claim 15, wherein the processor is to:
when the spatial relationships defined in the depth map indicate that the objects intersect the virtual boundary, alter the standard projection surface based on the spatial relationships to account for portions of the objects that intersect the virtual boundary; and
when the spatial relationships defined in the depth map do not indicate that the objects intersect the virtual boundary, select the standard projection surface.
